(19) United States
(12) Patent Application Publication
(10) Pub. No.: US 2002/0172580 A1
(43) Pub. Date: Nov. 21, 2002

(54) Workpiece-carrier changeover arrangement and the method for changing over workpiece carriers

(76) Inventors: Lothar Mueller, Heidelberg (DE); Dietmar Schuetz, Muenchen (DE); Holger Schulz, Bruchsal (DE); Uwe Waeckerle, Bruchsal (DE)

Correspondence Address: SCHIFF HARDIN & WAITE, 6600 SEARS TOWER, 233 S WACKER DR, CHICAGO, IL, 60606-6473, US

(21) Appl. No.: 10/126,771

(22) Filed: Apr. 19, 2002

(30) Foreign Application Priority Data
Apr. 19, 2001 (DE) 10119229.0

(51) Int. Cl. B65G 1/00; B23Q 7/00

(52) U.S. Cl. 414/331.14; 414/331.17

(57) ABSTRACT

A workpiece-carrier changeover apparatus removes a workpiece carrier from a storage unit and moves it in a first direction into a buffer storage position. Any workpiece carrier in a supply position is then moved back toward the storage unit either simultaneously with that movement or thereafter so that the workpiece carrier in the buffer storage position can be moved into the supply position.

### BACKGROUND OF THE INVENTION

The present invention relates to a workpiece-carrier changeover arrangement and to a method for changing over workpiece carriers which are arranged in a storage unit, that is provided with a plurality of storage positions, and which workpiece carriers are moved to a supply position outside the storage unit in order to be processed by a handling arrangement.

For example, in the case of electrical components, different carriers are used for supplying the components. It is common practice to supply the components in tray-like workpiece carriers or else flat magazines. These workpiece carriers are stored in a storage unit. In order to remove the component from the workpiece carrier, it is necessary for one of the workpiece carriers to be conveyed away from the storage unit into a removable position. At the removable position, the components may be removed from the workpiece carrier by means of a handling arrangement.

If the workpiece carrier at the removal position has been completely emptied or if a component which is present on another workpiece carrier other than the workpiece carrier supplied at the removal position is required, then the workpiece carrier has to be exchanged. It is usually the case for this purposes that by means of a transporting arrangement, the workpiece carrier which has been unloaded or is to be changed over is removed from the removal position, which is adjacent the handling arrangement, and moved to the storage unit. Another workpiece carrier is then removed from the storage unit and moved into the removal position by means of the transporting unit.

This method of changing over a workpiece carrier using the conventional changeover arrangement is very slow and laborous. This may result in delays in the removal process of the components and, thus, in a delay in the process for which the components are to be made available. However, for example, pick-and-place apparatus for components are designed for a high throughput, with the result that it is undesirable to extend the processing time of the pick-and-place apparatus by an external apparatus, for example the changeover arrangement for workpiece carriers.

### SUMMARY OF THE INVENTION

It is an object of the present invention to specify a workpiece-carrier changeover arrangement and a method for changing over workpiece carriers which have a high level of flexibility and a shorter time for changing over the workpiece carrier.

The object is achieved by a workpiece-carrier changeover arrangement for workpiece carriers which are arranged in a storage unit which has a plurality of storage positions and which workpiece carriers are moved to a supply position outside the storage unit in order to be processed by a handling arrangement. The changeover arrangement includes a first transporting apparatus for moving the workpiece carriers in a first transporting direction between a storage position in the storage unit and a buffer storage position in the vicinity of the supply position, the first transporting apparatus is movable counter to the first transporting direction between the supply position and the storage position in the storage unit, a second transporting apparatus for moving the workpiece carriers out of the buffer storage position in a second transporting direction at an angle to the first transporting direction into the supply position.

The workpiece carrier changeover arrangement makes it possible to isolate the operation of feeding the workpiece carrier from the storage position in a storage unit to a supply position and the returning of the same. The provision of a buffer storage position makes it possible for the next workpiece carrier which is to be processed to be moved into the buffer storage position by means of the first transporting apparatus while the handling arrangement processes another workpiece carrier in the supply position. If the workpiece carrier in the supply position is to be changed over, all that is necessary for the workpiece carrier to be moved out of the supply position by means of the first transporting apparatus and for a second transporting apparatus to move the additional workpiece carrier provided in the buffer storage position from the buffer storage position into the supply position. Since the buffer storage position is arranged in the vicinity of the supply position, the second transporting apparatus only has to cover a short distance. It is thus possible for the workpiece carrier to be changed over very quickly.

According to a development of the invention, the first transporting apparatus is divided into a feed unit and a return unit. The feed unit and the return unit can be moved simultaneously independently of one another and it is, thus, possible for a workpiece carrier to be moved in the first transporting direction by means of the feed unit while a workpiece carrier can be moved in a counter direction by the return unit. In contrast to the configuration mentioned above, which provides a first transporting apparatus by means of which, in the case of a changeover, the workpiece carrier which is to be removed from the supply position has to be moved, the improvement for this development has a separate means in each case for feeding the workpiece carrier from the storage unit into the buffer storage position and for returning the workpiece carrier from the supply position into the storage unit. This allows an even quicker changeover operation, since, even while the workpiece carrier which is to be changed over is transported back from the supply position, another or further workpiece carrier can be moved to the buffer storage position.

In another development of the present invention, the second transporting apparatus is arranged on the first transporting apparatus and the second transporting apparatus can be moved together with the workpiece carrier in the first transporting direction. This development provides an integral transporting apparatus which combines the functions of the first transporting apparatus and of the second transporting apparatus in a single apparatus. A particularly compact construction of the transporting apparatus is possible here and simplified handling of the workpiece carrier is provided, since the workpiece carrier no longer has to be transferred between the first transporting apparatus and the second transporting apparatus.

A still further development of the invention includes additional integral transporting apparatuses comprising a third transporting apparatus which is constructed in a manner analogous to the first transporting apparatus and a fourth transporting apparatus which is constructed in a manner analogous to the second transporting apparatus. The third transporting apparatus is arranged parallel to the first transporting apparatus. By virtue of this additional development, the advantages followed from the earlier developments are also realized for the additional transporting apparatuses.

In each of these developments, the first transporting direction is essentially horizontal and the second transporting direction is essentially vertical. The workpiece carriers in the storage unit are arranged essentially vertically one above the other and a fifth transporting apparatus is provided so that a storage unit or the storage position can be moved in a vertical direction.

The configuration of the workpiece-carrier changeover arrangement thus has the workpiece carriers arranged vertically one above the other in a storage unit and by way of the first horizontal transporting direction and a second vertical transporting direction. This storage unit is designed so that it can be moved in a vertical direction by an additional transporting apparatus. This makes it possible to limit movement of the first and third transporting apparatuses to one movement direction, i.e., the horizontal direction. Since the storage unit is moved in a vertical direction, for example relative to the first and third transporting apparatuses, it is nevertheless possible for all the storage positions of the storage unit to be reached by means of the first and third transporting apparatuses.

The storage unit ideally has a first sub-region and a second sub-region. This has the advantage that it is possible to store fully-loaded workpiece carriers, for example in the first sub-region, and partially emptied workpiece carriers in the second sub-region. However, it is also possible to store partially-emptied or full workpiece carriers in one sub-region and completely emptied workpiece carriers in another sub-region. It is possible here, for example during operation of the changeover apparatus using merely the first sub-region to supply the workpiece carriers while removing the completely emptied workpiece carriers in the other or second sub-region of the storage unit without this having an effect on the operation of the workpiece-carrier changeover arrangement with the first sub-region.

In order to provide an even higher level of flexibility, provisions are made for the first sub-region and the second sub-region of the storage unit to be configured so that they can be coupled together. All kinds of coupling apparatuses are possible here, for example electromagnetic, hydraulic and/or pneumatic coupling apparatuses.

However, it is also possible for the first sub-region and the second sub-region of the storage unit to be arranged separately from one another. In this case, the sub-regions may be arranged one above the other and/or one behind the other in relation to one of the transporting directions. It is favorable for the first sub-region to be arranged beneath the first and third transporting apparatuses so that it is directed toward the handling unit and for the second sub-region to be arranged above the first and second transporting apparatuses so that it is directed away from the handling arrangement. It is also possible for the storage unit to be sub-divided into more than two sub-regions.

The invention also provides a method of changing over workpiece carriers, it being the case that a workpiece carrier, by means of a first transporting apparatus, is moved in a first transporting direction to a buffer storage position in the vicinity of the supply position, the workpiece carrier, by means of a second transporting apparatus, is moved in a second transporting direction from the buffer storage position to a supply position and the workpiece carrier, by means of the first transporting apparatus, is moved counter to the first transporting direction from the supply position into one of the storage positions. The method according to the invention provides the advantage that the necessary transporting movements are isolated in each case. A first transporting apparatus provides the movement between the supply position and the storage unit and between the buffer storage position in the vicinity of the supply position and the storage positions of the storage unit. A second transporting apparatus ensures the transportation from the buffer storage position into the supply position.

A development of the method provides that the storage unit is sub-divided into at least a first sub-region and a second sub-region, which are spaced apart from one another, and for the workpiece carriers to be removed selectively from the sub-regions and moved to the buffer storage position and to be moved from the supply position into the other sub-region. This has the advantage that one of the supply regions may be provided merely with completely empty workpiece carriers. These can be exchanged for fully-loaded workpiece carriers and moved to a corresponding location of the other sub-region during operation of the changeover arrangement. Continuous operation without disruptive changeover time for the changeover arrangement is made possible as a result of this arrangement.

For an even higher level of flexibility, the first sub-region and the second sub-region may be coupled mechanically to one another, for example, during the operation. In this case, coupling may be carried out during operations or prior to or following operations. This means that both operations with a single storage unit and operations with storage units sub-divided into a plurality of sub-regions are possible. The coupling of the sub-regions is expedient, in particular, when, for example, a large number of components of the same type are supplied to the workpiece carrier and the components are merely to be removed one after the other from the individual workpiece carriers.

Other advantages and features of the invention will be readily apparent from the following description of the preferred embodiment, the claims and drawings

### BRIEF DESCRIPTION OF THE DRAWINGS

FIG. 1 is a schematic view of a preferred embodiment of the present invention;

FIG. 2 is a schematic view of another embodiment of the invention;

FIG. 3 is a schematic perspective view of a still further embodiment of the invention; and

FIG. 4 is a detailed schematic view of portions of FIG. 3.

### DESCRIPTION OF THE PREFERRED EMBODIMENTS

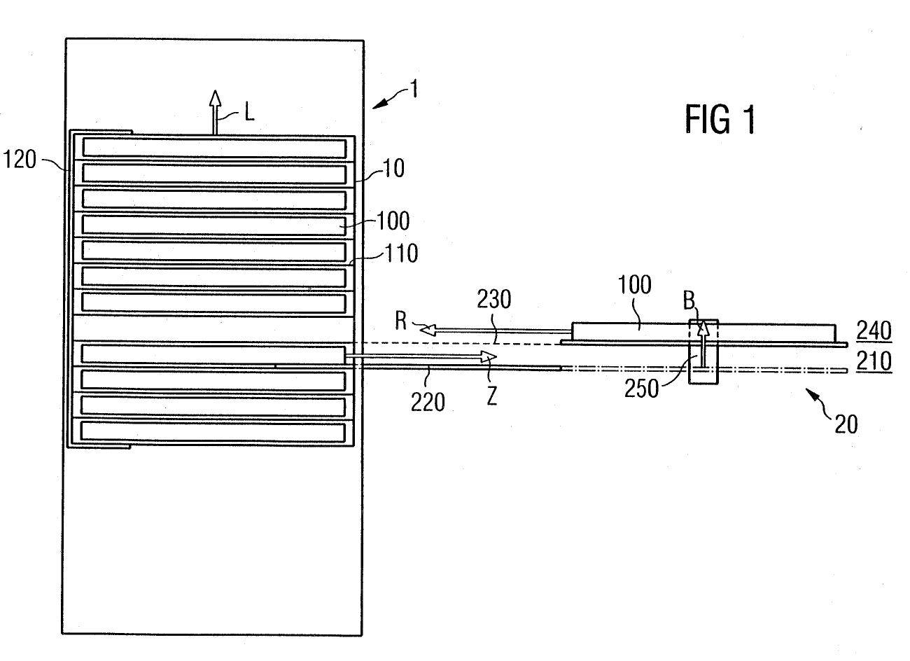

The principles of the present invention are particularly useful when incorporated in a workpiece-carrier changeover arrangement, generally indicated at 1 in FIG. 1, which has a storage unit 10 and a transporting arrangement or apparatus 20. The storage unit 10 has a plurality of storage positions 110, which each receive a workpiece carrier 100, for example a flat-magazine carrier. Compartments or guide rails for accommodating the workpiece carriers in each case are provided, for example, in the storage position 110. The compartments are connected to one another, for example, by a frame 120. The compartments can be moved together with the frame 120 in a direction L. A drive (not shown) is used for this purpose.

The transporting apparatus, generally indicated at 20 in FIG. 1, is arranged on the storage unit 10. The transporting apparatus has a feed unit 220 which will transport a workpiece carrier 100 out of a storage position 110 in a direction of arrow Z into a buffer storage position 210. A return unit 230 is arranged above the feed unit 220, as seen in the direction L. The return unit, 220 will take a workpiece carrier and move it in a direction of arrow R from a supply position or removal position 240 of the transporting apparatus 20 into a storage position 110 of the storage unit 10. In this case, the transporting apparatus and the storage unit are arranged, for example, so that the transporting apparatus can simultaneously act on two storage positions of the storage unit, which are located one above the other, for example, to remove a workpiece carrier 100 from the corresponding storage position and insert another carrier into the latter position. The transporting apparatus 20 is further provided with a drive 250, by which a workpiece carrier can be moved out of the buffer storage position 210 into a supply position 240 in a second transporting direction indicated by the arrow B. The drive 250 in this case may be arranged in a stationary manner on the transporting apparatus 20 in the vicinity of the buffer storage 210 and of the supply position 240. It is also possible for the drive 250 to be arranged on the feed unit 220 and/or on the return unit 230. The drive 250 corresponds in functional terms to a second transporting apparatus.

If one of the workpiece carriers 100, which is arranged at the supply position 240, is designated as a type 2 and is to be changed over for another workpiece carrier, which is designated as a type 3, the process functions as follows. The type 3 workpiece carrier is removed from the storage unit 10 and moved to the buffer storage position 210. At the same time, or a short time thereafter, the workpiece carrier designated as a type 2, which is at the supply position 240, is moved by means of a return unit 230 and is returned in the direction of arrow R from the supply position 240 into a free storage position 110 of the storage unit 10. The type 3 workpiece carrier arranged in the buffer storage position 210 is then moved by means of the drive 250 from the buffer storage position 210 into the supply position 240. At the same time as the type 3 workpiece carrier is raised or moved to the supply position 240, it is possible for the frame 120 to move the distance of one level, which corresponds to the height of the storage position 110 or of a corresponding compartment of the storage unit 10 in the direction of the arrow L. This prepares the workpiece-carrier changeover arrangement for the next changeover, which can take place in a manner identical to the above-described changeover of the workpiece carrier.

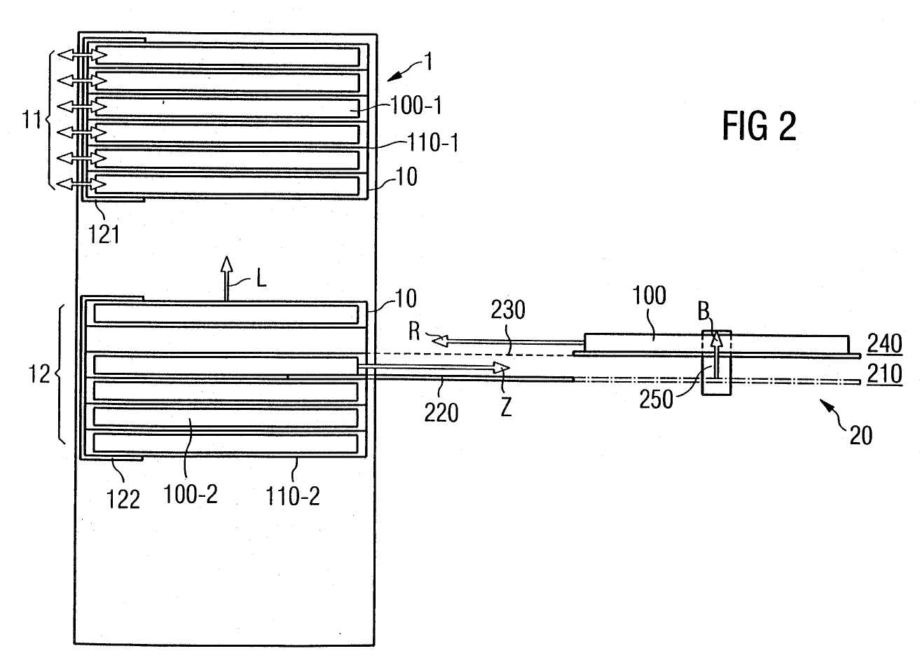

A modified embodiment of the invention is illustrated in FIG. 2. It differs from the embodiment which is seen in FIG. 1 in that the storage unit 10 has two storage regions 11 and 12. The first storage region 11 constitutes a reserve storage region. It has a frame 121 in which a plurality of storage positions 110-1 are arranged, for example, as storage compartments. The workpiece carrier 100-1 may be arranged in each storage position 110-1. In a manner similar to the first storage region 11, a second storage region 12 has a frame 122, which is provided with a plurality of storage positions 110-2. The storage positions 110-2 may each be occupied by a workpiece carrier 100-2.

With the exception of the following, the embodiment according to FIG. 2 functions in a manner essentially identical to the embodiment according to FIG. 1. The operation of depositing workpiece carriers 100-1 or 100-2 and removing them from the storage unit 10 are different. In the case of the modified embodiment of the invention, it is possible for a workpiece carrier 100-1 to be removed from the first storage region 11 and a workpiece carrier 100-2 to be removed from the second storage region 12, and, respectively, deposited therein in a selected manner. It is possible, here, for example by means of the feed arrangement 220, for a workpiece carrier 100-2 to be removed from the second storage region 12 and moved into the buffer storage position 210 while the workpiece carrier 100 is moved from the supply position 240 into a storage position 110-2 of the second storage region 12.

It is likewise possible, however, for the workpiece carrier 100 to be moved from the supply position 240 into a storage position 110-1 of the first storage region 11. For this purpose, the frame 121 together with the storage positions 110-1 are moved by means of a drive (not shown) in a direction of arrow L relative to the transporting apparatus 20.

This set-up makes it possible, for example, for workpiece carriers 100-1 or 100-2 to be exchanged by an operator in one respective storage region 11 or 12 while the changeover operation can continue without interruption by way of the other storage region 12 or 11.

In the case of those embodiments of the invention which can be seen from FIGS. 1 and 2, it is also possible, for example, to change over empty workpiece carriers 100 or 100-1, 100-2 in that, during a dead period in which no workpiece is to be removed from the workpiece carrier 100, the empty workpiece carrier 100 is removed from the supply position 240 and a full workpiece carrier 100, which is of a type corresponding to the workpiece 100 which has been removed from the supply position 240, is inserted at the buffer storage region 210 and then moved to the supply position 240.

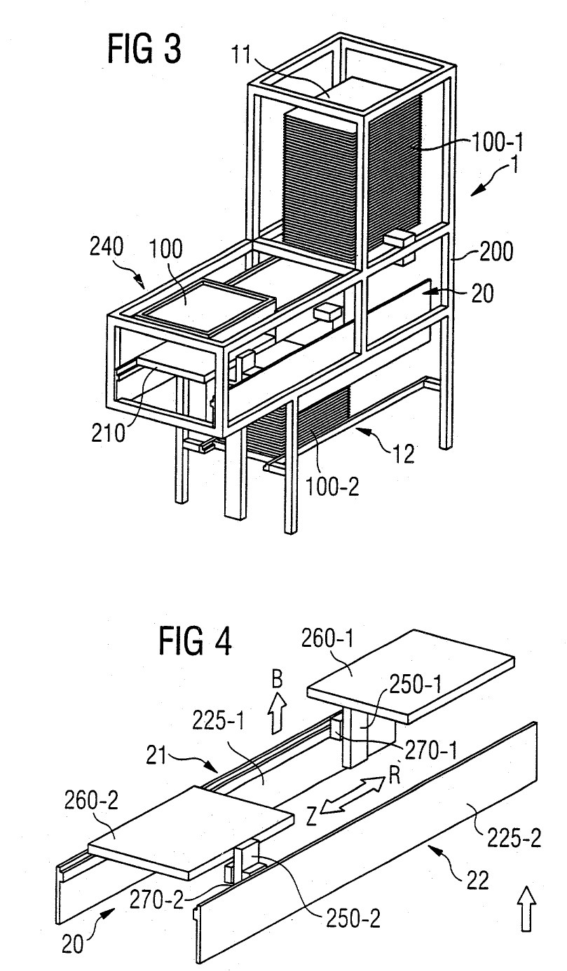

FIGS. 3 and 4 show, schematically, an additional, preferred embodiment of the invention. Accordingly, a workpiece-carrier changeover arrangement, generally indicated at 1, has a chassis or frame 200. A first storage unit 11 and a second storage unit 12 are arranged in this frame or chassis. A transporting arrangement or apparatus 20 is also located in the chassis. By means of the transporting arrangement 20, workpiece carriers 100-1 of the first storage unit 11 and workpiece carriers 100-2 of the second storage unit 12 can be moved in a first transporting direction shown by a double-arrow with a direction Z being opposite the direction R. The transporting arrangement 20 has two essentially identical transporting units, generally indicated at 21 and 22, which are arranged parallel to one another. Each of these transporting units 21 and 22 is provided with a first respective drive, with the unit 21 having a drive 270-1 which runs along a guide arrangement 225-1 and the unit 22 having a drive 270-2 which runs along a guide arrangement 225-2. The guide arrangements 225-1 and 225-2 extend parallel to the first transporting direction defined by the directions Z and R. The first drive 270-1 has a second drive 250-1 while the first drive 270-2 has a second drive 250-2. The second drives 250-1 and 250-2 can execute movement in a second transporting direction B, which is substantially at right angles to the direction defined by the two directions Z and R. The second drive 250-1 supports a mount or plate 260-1 while the second drive 250-2 supports a mount or plate 260-2. Each of these mounts 260-1 and 260-2 are for respective workpiece carriers, such as 100-1 and 100-2. The mounts 260-1 and 260-2 are arranged so that they can be directed toward one another and can run along the same transporting path in the first transporting direction Z or R.

As can be seen from FIG. 3, the transporting arrangement or apparatus 20 is arranged between the first storage unit 11 and the second storage unit 12, as seen in the second transporting direction B. The first storage unit 11 and the second storage unit 12 are offset in relation to one another, as seen in the first transporting direction Z or R. By means of the second drives 250-1 and 250-2, it is possible for workpiece carriers to be moved between a buffer storage position 210 and a removal or supply position 240, which is arranged above the buffer storage position 210, as seen in the second transporting direction B. The first drives 270-1 and 270-2 make it possible to move a workpiece carrier from a storage position in the first storage unit 11 and the second storage unit 12 to the buffer storage position 210 and from the removal or supply position 240 back to the storage units 11 and 12.

The operation of changing over a workpiece carrier from the removal position 240 is explained in more detail hereinbelow.

First of all, by means of the first transporting unit 21, the workpiece carrier 100 is moved in the transporting direction R from the removal position 240 to the first storage unit 11 and, there, is inserted into the storage position of the first storage unit 11. At the same time, by means of the second transporting unit 22, a workpiece carrier 100-2, which is to be supplied subsequently, is removed from the second storage unit 12 and moved to the buffer position 210. In this case, the workpiece carrier 100-2 merely has to be moved in the second transporting direction B by the drive 250-2 and then in the direction Z by the drive 270-2 to the buffer storage position 210. Subsequently, the workpiece carrier 100-2 is moved by means of the second transporting unit 22 from the buffer storage position 210 into the removal position 240. In this case, the workpiece carrier 100-2 is moved in the second transporting direction B by means of the second drive 250-2 of the second transporting unit 22.

It is also possible for the workpiece carrier 100 which is to be removed to be inserted into the same storage unit from which the workpiece carrier which is to be supplied has just been removed.

Each of the storage units can be provided with a drive which will move the unit in either the first transporting direction and/or the second transporting direction in the chassis or frame 200. It is also possible to provide just one of the two storage units 11 or 12 in the workpiece-carrier changeover arrangement.

Each of the drives 250-1 and 250-2 can be made, for example, as a chain drive which has chains with carry-along elements on both sides of the feed unit 220 and the return unit 230. The chains run essentially in the second transporting direction B. The axes of rotation with chain wheels for the chains are arranged above and beneath the feed unit 220 and the return unit 230. The axes of rotation of the chains run essentially in a feed direction Z or a return direction R.

Instead of chain drives, a drive using conveyor screws is also conceivable. The conveying screws, likewise, are arranged on both sides of the feed arrangement 220 and of the return arrangement 230 and extend in the second transporting direction B.

It is also possible to provide more than one buffer storage position. In this case, a common feed arrangement 220 may serve all of the buffer storage positions or one feed unit may be provided for each buffer storage position.

Although various minor modifications may be suggested by those versed in the art, it should be understood that we wish to embody within the scope of the patent granted hereon all such modifications as reasonably and properly come within the scope of our contribution to the art.

We claim:

1. A workpiece-carrier changeover apparatus for transporting workpiece carriers which are provided in a storage unit having a plurality of storage positions and transporting them to a supply position outside the storage unit in order to be processed by a handling arrangement, said changeover arrangement comprising a first transporting apparatus for moving a workpiece carrier in a first transporting direction between a storage position in the storage unit and a buffer storage position in the vicinity of the supply position, the first transporting apparatus being movable in a counter direction to the first transporting direction between the supply position and a storage position in the storage unit and a second transporting apparatus for transporting a workpiece carrier out of the buffer storage position in a second transporting direction at an angle to the first transporting direction into the supply position.

2. A workpiece-carrier changeover apparatus according to claim 1, wherein the first transporting arrangement has a feed unit for transporting the workpiece carriers in the first transporting direction from the storage position in the storage unit to the buffer storage position and a return unit moving counter to the first transporting direction from the supply position back to a storage position in the storage unit, the feed unit can move the workpiece carrier along the first transporting direction and the return unit can move the workpiece carrier along the first transporting direction opposite to the feed unit.

3. A workpiece-carrier changeover apparatus according to claim 2, wherein the storage unit is sub-divided into a first sub-region and a second sub-region, the workpiece carriers can be moved out of the storage position in the first sub-region and into the buffer storage position while other workpiece carriers can be moved out of the supply position into the storage position of the second sub-region.

4. A workpiece-carrier changeover apparatus according to claim 3, which includes a mechanical coupling for connecting the first sub-region of the storage unit to the second sub-region, said mechanical coupling being selected from an electromagnetic coupling apparatus, a hydraulic coupling apparatus and a pneumatic coupling apparatus.

5. A workpiece-carrier changeover apparatus according to claim 3, wherein the first sub-region and the second sub-region are spaced apart from one another in the first transporting direction.

6. A workpiece-carrier changeover apparatus according to claim 3, wherein the first sub-region and the second sub-region are spaced apart from one another in the second transporting direction.

7. A workpiece-carrier changeover apparatus according to claim 1, wherein the second transporting apparatus is arranged on the first transporting apparatus.

8. A workpiece-carrier changeover apparatus according to claim 7, wherein the second transporting apparatus can be moved together with the workpiece carrier in the first transporting direction.

9. A workpiece-carrier changeover apparatus according to claim 7, which includes a third transporting apparatus similar to the first transporting apparatus and a fourth transporting apparatus similar to the second transporting apparatus, the third transporting apparatus and the first transporting apparatus both moving a workpiece carrier along the first transporting direction from the storage unit to the buffer storage station and from the supply position back to the storage unit.

10. A workpiece-carrier changeover apparatus according to claim 1, wherein the first transporting direction is essentially horizontal and the second transporting direction is essentially vertical, the workpiece carrier in the storage unit are arranged essentially vertically one above the other and the storage unit has an arrangement for moving the workpiece carriers in a vertical direction in the storage unit.

11. A method of changing workpiece carriers between a storage unit having a plurality of storage positions and a supply position in order to be processed by a handing arrangement, said method comprising moving a workpiece carrier by a first transporting apparatus in a first transporting direction from a storage position of the storage unit to a buffer storage position adjacent the supply position, moving a workpiece carrier in a second transporting direction from the buffer storage position to the supply position and moving a workpiece carrier from the supply position back to a storage position of the storage unit in said first transporting direction.

12. A method according to claim 11, wherein the storage unit has a first sub-region and a second sub-region which are spaced apart from one another along one of said first and second transporting directions, said method further comprising removing a workpiece carrier from one of the first and second sub-regions and moving the second workpiece carrier to the buffer storage position and moving a workpiece carrier at the supply position from the supply position into one of the second and first sub-regions.

13. A method according to claim 12, wherein the first sub-region and the second sub-region are coupled to one another by means of a mechanical coupling apparatus.

14. A method according to claim 11, wherein the first transporting apparatus has a feed unit and a return unit and said method comprises moving the workpiece carrier in the first transporting direction from the storage position in the storage unit to the buffer storage position by the feed unit, moving the workpiece carrier in the supply position into a storage position on the storage unit along the first transporting direction by the return unit, the feed unit and the return unit both being movable along the first transporting direction from the storage unit toward the supply position and counter thereto.

15. A method according to claim 11, which includes a second transporting apparatus being arranged on the first transporting apparatus so that moving in the first transporting direction moves the second transporting apparatus with any workpiece carrier.
